(19) United States
(12) Patent Application Publication
(10) Pub. No.: US 2026/0249550 A1
(43) Pub. Date: Aug. 27, 2026

(54) THREE-DIMENSIONAL PRINTING APPARATUS

(71) Applicant: AtomForm Technology (Shenzhen) Co., Ltd., Shenzhen (CN)

(72) Inventors: Bin LIU, Shenzhen (CN); Jigeng SHANG, Shenzhen (CN); Jirong HU, Shenzhen (CN)

(21) Appl. No.: 19/438,474

(22) Filed: Dec. 31, 2025

Related U.S. Application Data
(63) Continuation of application No. PCT/CN2025/143276, filed on Dec. 17, 2025.

(30) Foreign Application Priority Data
Feb. 21, 2025 (CN) 202510201423.8

(51) Int. Cl. B29C 64/209; B22F 12/50; B33Y 30/00; B33Y 40/00

(52) U.S. Cl. CPC B29C 64/209; B22F 12/50; B33Y 30/00; B33Y 40/00

(57) ABSTRACT

Disclosed herein is a three-dimensional printing apparatus, including a load-carrying member and a storage device, where the load-carrying member has a first limiting portion; the storage device is configured to store the load-carrying member and includes a fixed base and a mounting member, the mounting member being movably disposed on the fixed base and having a second limiting portion configured to engage with the first limiting portion; and the mounting member is configured to, when an interference occurs between the first limiting portion and the second limiting portion, move relative to the fixed base following movement of the first limiting portion.

### CROSS-REFERENCE TO RELATED APPLICATION

The present application is a continuation of International Application No. PCT/CN2025/143276, filed on December 17, 2025, which claims priority to Chinese Patent Application No. 202510201423.8, filed with the China National Intellectual Property Administration on February 21, 2025 and titled “STORAGE DEVICE AND MULTI-DIMENSIONAL PRINTING APPARATUS”. Both of the applications are incorporated herein by reference in their entireties.

### TECHNICAL FIELD

The present application relates to the technical field of multi-dimensional printing and, in particular, to a three-dimensional printing apparatus.

### BACKGROUND

Three-dimensional (3D) printing refers to a method for fabricating models with complex geometric shapes using a single material or multiple materials. It is a technique that constructs objects by sequentially printing layers based on a digital model file, utilizing adhesive materials such as powdered metals or plastics. During the printing process, it is often necessary to replace different load-carrying members to achieve printing with multiple materials.

In related art, when a load-carrying member is replaced, a drive member of a multi-dimensional printer will align and place the replaced load-carrying member (such as a tool head) at a preset position on a storage rack.

However, the inventor has recognized that the aforementioned three-dimensional printer sometimes fails to store the load-carrying member.

### SUMMARY

An embodiment of the present application provides a three-dimensional printing apparatus, which can solve the technical problem of failure to store a load-carrying member.

The three-dimensional printing apparatus provided by the embodiment of the present application includes:

a load-carrying member having a first limiting portion; and

a storage device configured to store the load-carrying member and including a fixed base and a mounting member;

where the mounting member is movably disposed on the fixed base and has a second limiting portion configured to engage with the first limiting portion; and

the mounting member is configured to, when an interference occurs between the first limiting portion and the second limiting portion, move relative to the fixed base following movement of the first limiting portion, from a first position to a second position, so as to align and then engage the second limiting portion with the first limiting portion.

In an embodiment, a range of movement of the mounting member relative to the fixed base is not less than 0.1 mm.

In an embodiment, the second limiting portion is configured to engage with the first limiting portion in a nested manner along a preset direction; and

the mounting member is configured to, when the interference occurs between the first limiting portion and the second limiting portion, undergo a positional change relative to the fixed base along a preset planar direction following movement of the first limiting portion along the preset direction; and the preset direction is perpendicular to the preset planar direction.

In an embodiment, a range of movement of the mounting member relative to the fixed base along the preset direction is not greater than 1 mm.

In an embodiment, the fixed base has a first restricting portion configured to restrict a range of movement of the mounting member relative to the fixed base along the preset planar direction.

In an embodiment, the first restricting portion has a first restricting edge, and the mounting member has a second restricting edge, the first restricting edge being capable of abutting against the second restricting edge to restrict the range of movement of the mounting member relative to the fixed base along the preset planar direction; a first direction and a second direction are perpendicular to each other, and both the first direction and the second direction are parallel to the preset planar direction; and

when the mounting member moves relative to the fixed base, along the first direction, a distance variation between the first restricting edge and the second restricting edge located on the same side does not exceed 10 mm; and/or, when the mounting member moves relative to the fixed base, along the second direction, a distance variation between the first restricting edge and the second restricting edge located on the same side does not exceed 10 mm.

In an embodiment, the first restricting portion has a first restricting edge, and the mounting member has a second restricting edge, the first restricting edge being capable of abutting against the second restricting edge to restrict the range of movement of the mounting member relative to the fixed base along the preset planar direction; a first direction and a second direction are perpendicular to each other, and both the first direction and the second direction are parallel to the preset planar direction; and

a spacing between the first restricting edge and the second restricting edge located on the same side along the first direction is not greater than 10 mm; and/or, a spacing between the first restricting edge and the second restricting edge located on the same side along the second direction is not greater than 10 mm; and/or, the spacing between the first restricting edge and the second restricting edge located on the same side along the first direction is not less than 0.1 mm; and/or, the spacing between the first restricting edge and the second restricting edge located on the same side along the second direction is not less than 0.1 mm.

In an embodiment, the storage device further includes a second restricting portion connecting the fixed base and the mounting member to prevent the mounting member from detaching from the fixed base along the preset direction.

In an embodiment, the second limiting portion is configured to engage with the first limiting portion in the nested manner along the preset direction; the fixed base has a first restricting portion configured to restrict a range of movement of the mounting member relative to the fixed base along the preset planar direction; and the preset direction is perpendicular to the preset planar direction.

In an embodiment, the load-carrying member has a first mounting portion, the mounting member has a second mounting portion magnetically attracted to the first mounting portion, and the load-carrying member is fixed to the mounting member through magnetic attraction between the first mounting portion and the second mounting portion.

In an embodiment, at least one of the first limiting portion and the second limiting portion has a guiding surface at an end along the preset direction, the guiding surface intersects with the preset direction, and the guiding surface is capable of assisting in changing a position of the second limiting portion along the preset planar direction when the interference occurs between the first limiting portion and the second limiting portion.

In an embodiment, when the load-carrying member is provided in a plurality, the mounting member extends along a first direction, the second limiting portion is provided in a plurality, the plurality of second limiting portions are arranged at intervals along the first direction, and the plurality of second limiting portions correspond one-to-one and engage with the first limiting portions of the plurality of load-carrying members; and

each of the first limiting portions includes a plurality of first limiting sub-portions, each of the second limiting portions includes a plurality of second limiting sub-portions, the plurality of first limiting sub-portions are configured to correspond one-to-one and engage with the plurality of second limiting sub-portions, and at least two of the plurality of second limiting sub-portions are arranged at intervals along the first direction.

In an embodiment, a side of the load-carrying member facing the mounting member is provided with a mounting surface, the first mounting portion and the plurality of first limiting sub-portions are all fixed on the mounting surface, and the first mounting portion is fixed at a center of the mounting surface, with the plurality of first limiting sub-portions arranged around a periphery of the first mounting portion.

In an embodiment, the load-carrying member includes a tool head of the three-dimensional printing apparatus.

### BRIEF DESCRIPTION OF DRAWINGS

To describe the technical solutions in the embodiments of the present application more clearly, the accompanying drawings required to describe the embodiments will be briefly described below. Apparently, the accompanying drawings described below merely illustrate some embodiments of the present application. Those skilled in the art may further derive other drawings from these accompanying drawings without making creative efforts.

FIG. 1a is a schematic diagram illustrating an interference between a partial load-carrying member and a partial positioning column according to an embodiment of the present application.

FIG. 1b is a schematic diagram illustrating alignment between the partial load-carrying member and the partial positioning column according to an embodiment of the present application.

FIG. 2 is a perspective diagram of a load-carrying member and a storage device according to an embodiment of the present application.

FIG. 3 is an exploded diagram of the load-carrying member and the storage device in FIG. 2 of the present application.

FIG. 4 is an exploded diagram of the load-carrying member and the storage device in FIG. 2 of the present application from another perspective.

FIG. 5 is a perspective diagram of the load-carrying member and the storage device according to another embodiment of the present application.

FIG. 6 is an exploded diagram of the load-carrying member and the storage device in FIG. 5 of the present application.

FIG. 7 is an exploded diagram of the load-carrying member and the storage device in FIG. 5 of the present application from another perspective.

### Reference signs used in the figures:

1. load-carrying member; 11. first limiting portion; 112. first limiting sub-portion; 2. storage device; 21. fixed base; 211. first restricting portion; 2111. first restricting edge; 22. mounting member; 221. second limiting portion; 2211. second guiding inclined surface; 2212. second limiting sub-portion; 222. body; 223. mounting step; 224. through-hole; 225. second restricting edge; 26. second restricting portion; 261. head; 262. leg; 27. first mounting portion; 28. second mounting portion; 101. positioning column; 102. positioning hole; and 1021. hole wall.

### DESCRIPTION OF EMBODIMENTS

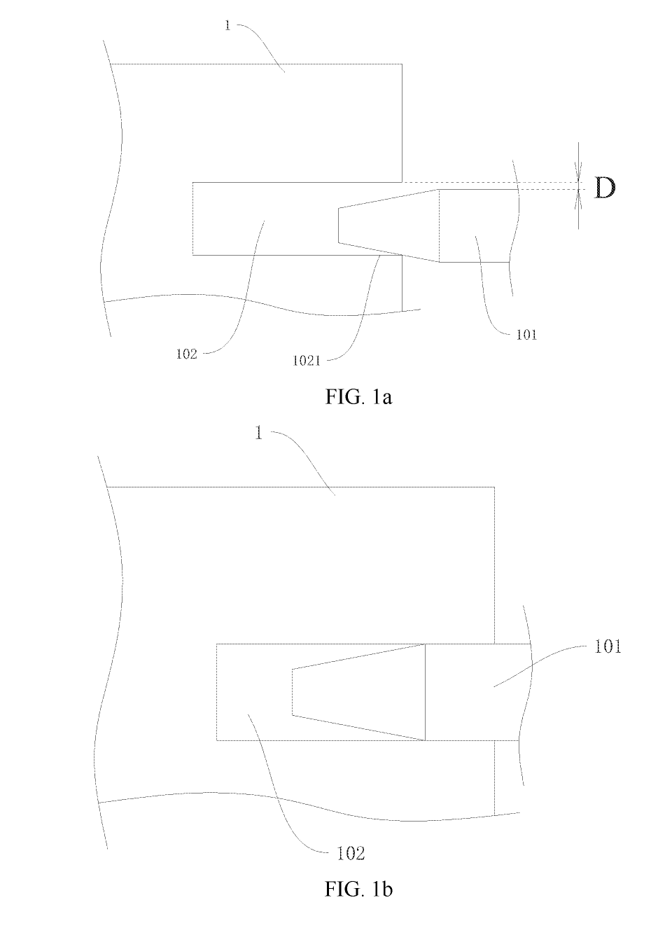

As described in the background, the multi-dimensional printers in related art have the problem of storage failure and rigid collisions between the load-carrying member and the storage rack. Through research, the inventor of the present application has found that this problem is caused by the load-carrying member 1 and the storage rack achieving alignment through a concave-convex fit (as shown in FIGS. 1a and 1b, the storage rack is provided with positioning columns 101, and the load-carrying member 1 is provided with positioning holes 102 that engage with the positioning columns 101). Influenced by factors such as deviations in the movement path of the load-carrying member 1, significant assembly errors, low accuracy of the load-carrying member 1, and low accuracy of the storage rack, it is highly likely that the positioning columns 101 of the load-carrying member 1 and the positioning holes 102 of the storage rack cannot perfectly achieve the concave-convex fit, thereby leading to storage failure. For example, in FIG. 1a, the positioning column 101 interferes with the hole wall 1021 of the positioning hole 102 and cannot be further inserted into the positioning hole 102.

To solve the above problem, the embodiments of the present application employ flexible storage. Thus, the storage device and the three-dimensional printing apparatus provided by the embodiments of the present application have the advantages of reducing accuracy requirements for the load-carrying member and the storage device, lowering path requirements for the load-carrying member, and improving the success rate of storing the load-carrying member.

The technical solutions in the embodiments of the present application will be clearly and completely described below with reference to the accompanying drawings in the embodiments of the present application. Apparently, the described embodiments are merely some rather than all of the embodiments of the present application. All other embodiments obtained by those skilled in the art based on the embodiments of the present application without making creative efforts shall fall within the scope of protection of the present application. Moreover, it should be understood that the embodiments described herein are merely intended to explain rather than limit the present application. In the present application, unless otherwise stated, directional terms such as “up” and “down” generally refer to the upper and lower directions in the actual operational or working state of a device, specifically the directions shown in the accompanying figures; while “inner” and “outer” are relative to the contour of the device.

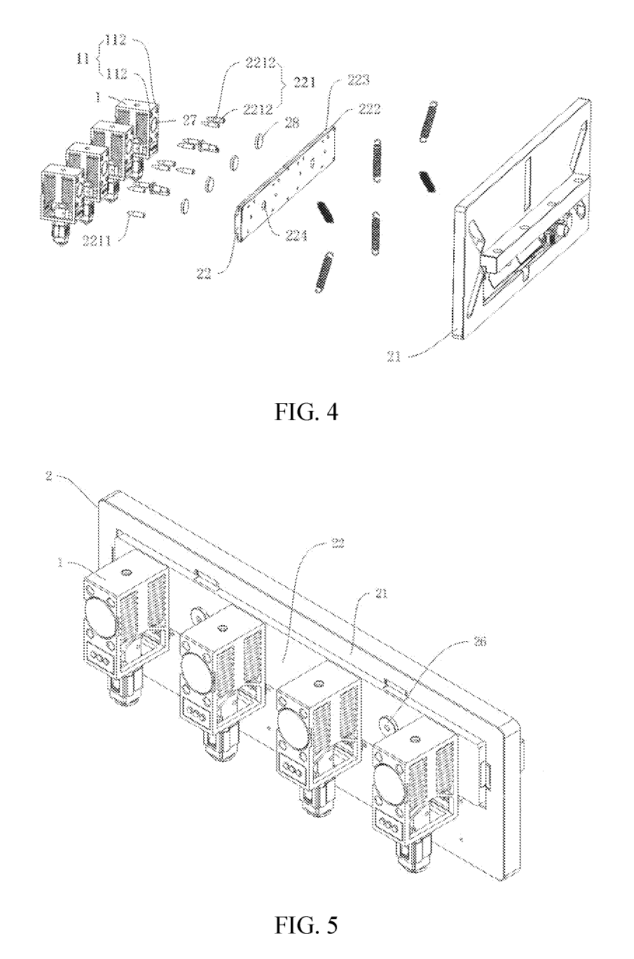

Referring to FIGS. 2-7, an embodiment of the present application provides a three-dimensional printing apparatus, including a load-carrying member 1 and a storage device 2, where the three-dimensional printing apparatus may be a 3D printing device and may perform printing operations; the load-carrying member 1 has a first limiting portion 11; the storage device 2 is configured to store the load-carrying member 1 and includes a fixed base 21 and a mounting member 22; and the mounting member 22 is movably disposed on the fixed base 21 and has a second limiting portion 221 configured to engage with the first limiting portion 11. When an interference occurs between the first limiting portion 11 and the second limiting portion 221, the mounting member 22 is capable of moving relative to the fixed base 21 following movement of the first limiting portion 11, from a first position to a second position, so as to align and then engage the first limiting portion 11 with the second limiting portion 221. In this embodiment, the interference refers to direct spatial contact between the first limiting portion 11 and the second limiting portion 221 during movement, preventing the first limiting portion 11 from continuing movement.

In this embodiment, by movably disposing the mounting member 22 on the fixed base 21, when an interference occurs between the first limiting portion 11 of the load-carrying member 1 and the second limiting portion 221 of the mounting member 22, the first limiting portion 11 will drive the mounting member 22 to move relative to the fixed base 21, thereby adjusting the position of the second limiting portion 221. This allows the position-adjusted second limiting portion 221 to align with the first limiting portion 11, thereby enabling the second limiting portion 221 and the first limiting portion 11 to complete engagement. Consequently, the load-carrying member 1 can be successfully assembled on the mounting member 22, which helps reduce the accuracy requirements for the load-carrying member 1 and the storage device 2, lowers the path accuracy requirements for the load-carrying member 1, and further improves the success rate of storing the load-carrying member 1. Simultaneously, when an interference occurs between the first limiting portion 11 and the second limiting portion 221, the mounting member 22 can move relative to the fixed base 21 following the movement of the first limiting portion 11 to adjust the position of the second limiting portion 221, thereby reducing rigid interference between the first limiting portion 11 and the second limiting portion 221 and, in turn, minimizing wear of the first limiting portion 11 and the second limiting portion 221.

In an embodiment, a range of movement of the mounting member 22 relative to the fixed base 21 is not less than 0.1 mm; and/or, the range of movement of the mounting member 22 relative to the fixed base 21 is not greater than 20 mm. That is to say, the range of movement of the mounting member 22 relative to the fixed base 21 is not less than 0.1 mm (e.g., the range of movement may take a value greater than or equal to 0.1 mm, such as 0.1 mm, 0.5 mm, 1 mm, 2 mm, 3 mm, 10 mm, 15 mm, or 20 mm); or, the range of movement of the mounting member 22 relative to the fixed base 21 is not greater than 20 mm (e.g., the range of movement may take a value less than or equal to 20 mm, such as 0.1 mm, 0.5 mm, 1 mm, 2 mm, 3 mm, 10 mm, 15 mm, or 20 mm); or, the range of movement of the mounting member 22 relative to the fixed base 21 is not less than 0.1 mm and not greater than 20 mm (e.g., the range of movement of the mounting member 22 relative to the fixed base 21 may take a value greater than or equal to 0.1 mm and less than or equal to 20 mm, such as 0.1 mm, 0.5 mm, 1 mm, 2 mm, 3 mm, 10 mm, 15 mm, or 20 mm).

Herein, when the mounting member 22 is in the first position, the coordinates of a point O on the mounting member 22 relative to the fixed base 21 are coordinates A; when the mounting member 22 is in the second position, the coordinates of the point O relative to the fixed base 21 are coordinates B; and the range of movement refers to the distance between the coordinates A and the coordinates B. For example, when the mounting member 22 is in the first position, the coordinates A of the upper-left vertex O of the mounting member 22 are (2, 3, 5); and when the mounting member 22 is in the second position, the coordinates B of the upper-left vertex O of the mounting member 22 are (1.5, 3, 5). Therefore, the distance between the coordinates A and the coordinates B is 0.5 mm, and when the mounting member 22 moves from the first position to the second position, the range of movement relative to the fixed base 21 is 0.5 mm. For another example, when the mounting member 22 is in the first position, the coordinates A of the upper-left vertex O of the mounting member 22 are (2, 3, 5); and when the mounting member 22 is in the second position, the coordinates B of the upper-left vertex O of the mounting member 22 are (2, 23, 5). Therefore, the distance between the coordinates A and the coordinates B is 20 mm, and when the mounting member 22 moves from the first position to the second position, the range of movement relative to the fixed base 21 is 20 mm. For yet another example, when the mounting member 22 is in the first position, the coordinates A of the upper-left vertex O of the mounting member 22 are (2, 3, 5); and when the mounting member 22 is in the second position, the coordinates B of the upper-left vertex O of the mounting member 22 are (3, 5, 7). Therefore, the distance between the coordinates A and the coordinates B is 3 mm, and when the mounting member 22 moves from the first position to the second position, the range of movement relative to the fixed base 21 is 3 mm.

Additionally, by restricting the range of movement of the mounting member 22 to not less than 0.1 mm, the fault tolerance capability of the three-dimensional printing apparatus can be improved. This ensures that even when there are significant deviations in the movement path accuracy of the load-carrying member 1, the positional accuracy of the storage device 2, and the positional accuracy of the load-carrying member 1, it is still possible to adjust the position of the mounting member 22 relative to the fixed base 21 to achieve precise alignment between the first limiting portion 11 and the second limiting portion 221. This allows the adjustment function of the storage device 2 to compensate for substantial positional errors, thereby enhancing the practicality of the storage device 2 and the success rate of assembling the load-carrying member 1.

Furthermore, through testing, the inventor has found that an excessively large range of movement of the mounting member 22 can cause the second limiting portion 221 to move excessively and become misaligned with the corresponding first limiting portion 11. By restricting the range of movement of the mounting member 22 relative to the fixed base 21 to not exceed 20 mm, this situation can be effectively improved. Additionally, when the mounting member 22 is provided with a plurality of second limiting portions 221 and is capable of assembling a plurality of load-carrying members 1, by restricting the range of movement of the mounting member 22 to not exceed 20 mm, it is ensured that, when the mounting member 22 is already assembled with a load-carrying member 1 and needs to assemble additional load-carrying members 1, it can prevent excessive deviations between the other second limiting portions 221 of the mounting member 22 and the first limiting portions 11 of the additional load-carrying members 1, which would otherwise prevent the first limiting portions 11 of the additional load-carrying members 1 from driving the corresponding second limiting portions 221 to move. Moreover, if the range of movement of the mounting member 22 exceeds 20 mm, after the load-carrying member 1 is fixed to the mounting member 22, the time required for the mounting member 22 to return to the first position becomes longer, leading to extended waiting times for assembling or removing the next load-carrying member 1, thereby reducing the operational efficiency of the three-dimensional printing apparatus. Furthermore, if the range of movement of the mounting member 22 exceeds 20 mm, excessive movement of the mounting member 22 may easily cause it to collide with nearby structural components, resulting in damage to both the mounting member 22 and the adjacent structural components.

In an embodiment, referring to FIGS. 2-7, the second limiting portion 221 is configured to engage with the first limiting portion 11 in a nested manner along a preset direction. For example, the first limiting portion 11 is a slot, and the second limiting portion 221 is a plug that engages with the slot; or, the first limiting portion 11 is a plug, and the second limiting portion 221 is a slot that engages with the plug; the first limiting portion 11 engages with the second limiting portion 221 in a nested manner through plug-in connection. As another example, the first limiting portion 11 is a male end of a snap-fit, and the second limiting portion 221 is a female end of the snap-fit; or, the first limiting portion 11 is a female end of the snap-fit, and the second limiting portion 221 is a male end of the snap-fit; the first limiting portion 11 engages with the second limiting portion 221 in a nested manner through snap-fitting. It is worth noting that the engagement between the first limiting portion 11 and the second limiting portion 221 in the nested manner results in a short and direct assembly path. This not only simplifies the path along which the drive member in the three-dimensional printing apparatus moves the load-carrying member 1 but also facilitates reducing the volume of the three-dimensional printing apparatus. Additionally, the engagement between the first limiting portion 11 and the second limiting portion 221 in the nested manner enables rapid connection or separation between the first limiting portion 11 and the second limiting portion 221 without the need for additional tools, thereby improving the storage efficiency of the load-carrying member 1. Moreover, the preset direction is perpendicular to the preset planar direction. If an interference occurs between the first limiting portion 11 and the second limiting portion 221 during movement along the preset direction, the mounting member 22 is capable of undergoing a positional change relative to the fixed base 21 along the preset planar direction following the movement of the first limiting portion 11 along the preset direction, thereby changing the position of the second limiting portion 221 along the preset planar direction. This enables the first limiting portion 11 to continue moving along the preset direction to complete the engagement between the first limiting portion 11 and the second limiting portion 221. In this embodiment, the preset direction is not specifically limited; for example, the preset direction may be parallel to the direction of gravity, or perpendicular to the direction of gravity, or intersect with but not be mutually perpendicular to the direction of gravity.

In an embodiment, a range of movement of the mounting member 22 relative to the fixed base 21 along the preset direction is not greater than 1 mm. For example, the range of movement of the mounting member 22 relative to the fixed base 21 along the preset direction may take a value less than or equal to 1 mm, such as 0.01 mm, 0.05 mm, 0.1 mm, 0.15 mm, 0.2 mm, 0.5 mm, 0.8 mm, or 1 mm.

In this embodiment, when an interference occurs between the first limiting portion 11 and the second limiting portion 221, the mounting member 22 is capable of undergoing a positional change along the preset planar direction following the first limiting portion 11. Meanwhile, the range of movement of the mounting member 22 relative to the fixed base 21 along the preset direction is not greater than 1 mm. The mounting member 22 mainly moves along the preset planar direction during movement, while its range of movement along the preset direction is very small. This avoids significant movement of the mounting member 22 simultaneously along both the preset planar direction and the preset direction, ensuring that the mounting member 22 essentially moves only along the preset planar direction. It reduces unnecessary movement of the mounting member 22 along the preset direction, allowing the second limiting portion 221 of the mounting member 22 to align more quickly with the first limiting portion 11 of the load-carrying member 1, thereby improving operational efficiency.

In an embodiment, the fixed base 21 has a first restricting portion 211, which is capable of restricting a range of movement of the mounting member 22 relative to the fixed base 21 along the preset planar direction. In this embodiment, the first restricting portion 211 can restrict the range of movement of the mounting member 22, preventing the mounting member 22 from detaching from the fixed base 21 due to excessive movement relative to the fixed base 21 and reducing overstretching of connecting components caused by excessive movement of the mounting member 22. At the same time, it can reduce the waiting time required for assembling or removing the next load-carrying member 1, thereby improving the operational efficiency of the three-dimensional printing apparatus. Furthermore, by restricting the range of movement of the mounting member 22 to a specific area, the first restricting portion 211 can prevent the mounting member 22 from moving too much and potentially colliding with other structural components outside the first restricting portion 211, thereby reducing damage to other structural components outside the first restricting portion 211 caused by the mounting member 22.

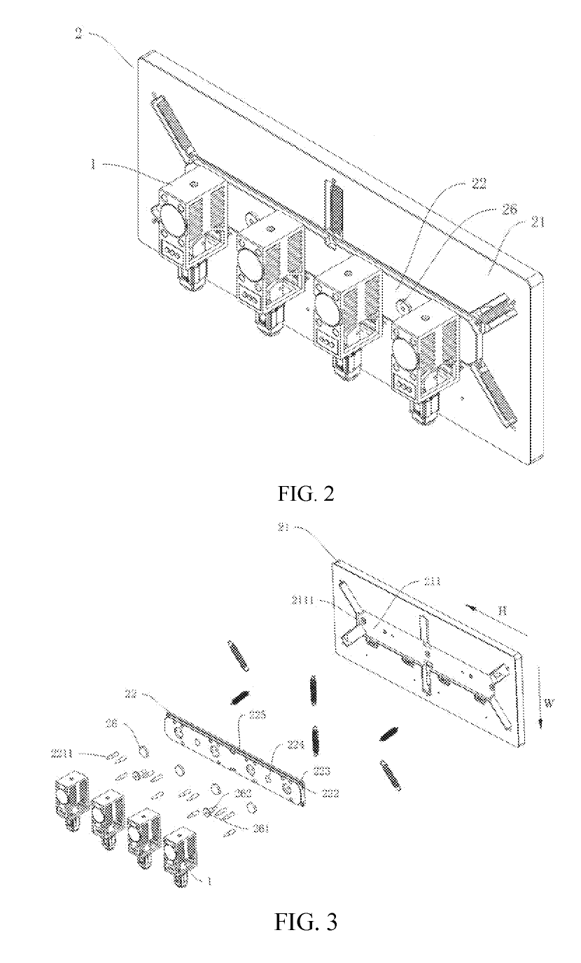

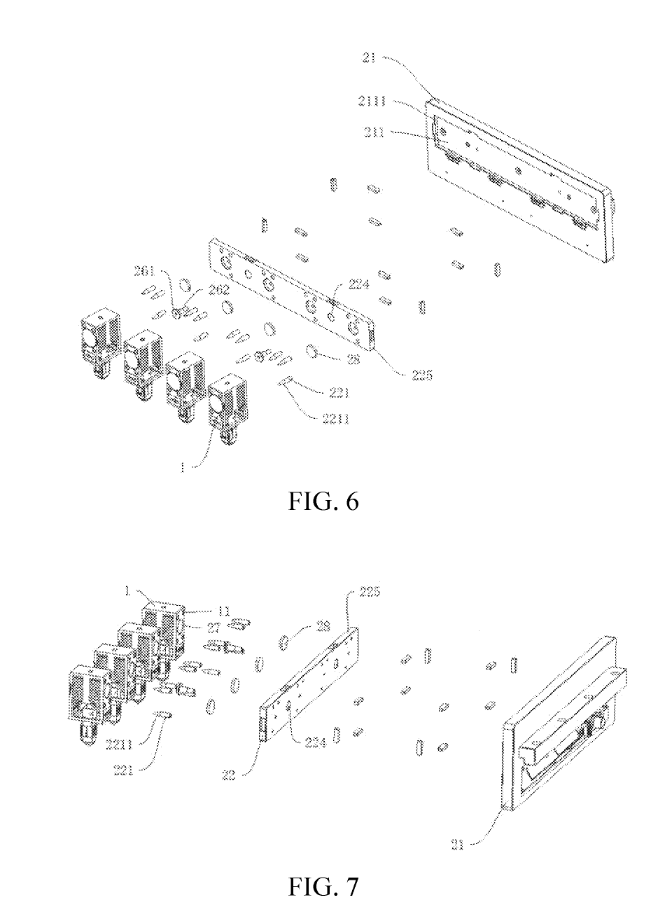

For example, the first restricting portion 211 may be a mounting groove disposed on the fixed base 21, with the mounting member 22 movably disposed in the mounting groove. The wall surrounding the mounting groove is capable of restricting the range of movement of the mounting member 22. In a specific embodiment, referring to FIGS. 3 and 6, the first restricting portion 211 may be a mounting groove disposed on the fixed base 21, the preset direction is the thickness direction of the fixed base 21, and the mounting groove is recessed along the preset direction and includes a side wall and a bottom wall. The mounting member 22 further includes a body 222 and a mounting step 223 fixed to the body 222, where the body 222 is located in the mounting groove, the mounting step 223 protrudes from the mounting groove, and the second limiting portion 221 is fixed to the mounting step 223. The mounting member 22 is movably disposed in the mounting groove, and the side wall of the mounting groove is capable of forming a limiting effect on the side wall of the body 222 of the mounting member 22, thereby restricting the range of movement of the mounting member 22 within the mounting groove.

For another example, the first restricting portion 211 may be a restricting member fixedly disposed on the fixed base 21. When the first restricting portion 211 and the second limiting portion 221 are engaged, the restricting member can restrict the range of movement of the mounting member 22. Specifically, the restricting member may restrict the movement of the mounting member 22 by abutting against the second limiting portion 221. Additionally, the restricting member can also prevent the mounting member 22 from detaching from the fixed base 21 during movement when the load-carrying member 1 and the mounting member 22 are engaged.

Referring to FIGS. 3 and 6, in an embodiment, the first restricting portion 211 has a first restricting edge 2111, and the mounting member 22 has a second restricting edge 225. The first restricting edge 2111 is capable of abutting against the second restricting edge 225 to restrict the range of movement of the mounting member 22 relative to the fixed base 21 along the preset planar direction, thereby preventing the mounting member 22 from detaching from the fixed base 21 due to excessive movement relative to the fixed base 21. In this embodiment, the shape of the first restricting edge 2111 is not limited; the first restricting edge 2111 may be linear, arc-shaped, or in another shape; and the first restricting edge 2111 may also be planar or curved. The shape of the second restricting edge 225 is also not limited; the second restricting edge 225 may be linear, arc-shaped, or in another shape; and the second restricting edge 225 may also be planar or curved.

In an embodiment, a first direction and a second direction are perpendicular to each other, and both the first direction and the second direction are parallel to the preset planar direction. When the mounting member 22 moves relative to the fixed base 21, along the first direction (as indicated by the H direction in FIG. 3), a distance variation between the first restricting edge 2111 and the second restricting edge 225 located on the same side does not exceed 10 mm (e.g., when the mounting member 22 moves relative to the fixed base 21, along the first direction, the distance variation between the first restricting edge 2111 and the second restricting edge 225 located on the same side may take a value less than or equal to 10 mm, such as 0.001 mm, 0.1 mm, 1 mm, 2 mm, 4 mm, 6 mm, 8 mm, or 10 mm); or, when the mounting member 22 moves relative to the fixed base 21, along the second direction (as indicated by the W direction in FIG. 3), a distance variation between the first restricting edge 2111 and the second restricting edge 225 located on the same side does not exceed 10 mm (e.g., when the mounting member 22 moves relative to the fixed base 21, along the second direction, the distance variation between the first restricting edge 2111 and the second restricting edge 225 located on the same side may take a value less than or equal to 10 mm, such as 0.001 mm, 0.1 mm, 1 mm, 2 mm, 4 mm, 6 mm, 8 mm, or 10 mm); or, when the mounting member 22 moves relative to the fixed base 21, along the first direction, the distance variation between the first restricting edge 2111 and the second restricting edge 225 located on the same side does not exceed 10 mm, and along the second direction, the distance variation between the first restricting edge 2111 and the second restricting edge 225 located on the same side does not exceed 10 mm.

In this embodiment, when the mounting member 22 moves relative to the fixed base 21, the distance variation between the first restricting edge 2111 and the second restricting edge 225 located on the same side is set to not exceed 10 mm. This can prevent the mounting member 22 from taking too long to return to the first position, as the assembly or removal of the next load-carrying member 1 typically requires waiting for the mounting member 22 to stabilize, which would otherwise lead to excessively long waiting times for the assembly or removal of the next load-carrying member 1, thereby reducing the operational efficiency of the three-dimensional printing apparatus. In a specific embodiment, referring to FIGS. 3 and 6, the fixed base 21 may be a vertical plate, the first restricting portion 211 may be a mounting groove disposed on the fixed base 21, the preset direction is the thickness direction of the fixed base 21, the preset planar direction is parallel to the bottom wall of the mounting groove, the mounting groove is recessed along the preset direction, and the first restricting edge 2111 is the side wall of the mounting groove; the mounting member 22 may be a vertical plate and has a side wall facing the side wall of the mounting groove, the second restricting edge 225 is the side wall of the mounting member 22, and when the mounting member 22 is movably disposed in the mounting groove, the side wall of the mounting groove can abut against the side wall of the mounting member 22 and form a limiting effect on the mounting member 22, thereby restricting the range of movement of the mounting member 22 relative to the fixed base 21 along the preset planar direction.

For example, the first direction H and the second direction W are perpendicular to each other, and both the first direction H and the second direction W are parallel to the preset planar direction. When the mounting member 22 moves relative to the fixed base 21, along the first direction H, the distance variation between the first restricting edge 2111 and the second restricting edge 225 located on the same side does not exceed 10 mm. For example, in FIG. 3, the first direction H is the left-right direction. The first restricting portion 211 has oppositely disposed first restricting edges 2111 on the left and right sides along the first direction H, and the mounting member 22 has oppositely disposed second restricting edges 225 on the left and right sides along the first direction H. When the mounting member 22 moves relative to the fixed base 21 along the first direction H, the distance variation between the second restricting edge 225 on the left side of the mounting member 22 and the first restricting edge 2111 on the left side of the first restricting portion 211 is between 0 mm and 10 mm; or, the distance variation between the second restricting edge 225 on the right side of the mounting member 22 and the first restricting edge 2111 on the right side of the first restricting portion 211 is between 0 mm and 10 mm.

For example, the spacing between the first restricting edge 2111 and the second restricting edge 225 located on the same side along the second direction W is not greater than 10 mm. For example, in FIG. 3, the second direction W is the up-down direction. The first restricting portion 211 has oppositely disposed first restricting edges 2111 on the upper and lower sides along the second direction W, and the mounting member 22 has oppositely disposed second restricting edges 225 on the upper and lower sides along the second direction W. When the mounting member 22 moves relative to the fixed base 21 along the second direction W, the distance variation between the second restricting edge 225 on the upper side of the mounting member 22 and the first restricting edge 2111 on the upper side of the first restricting portion 211 is between 0 mm and 10 mm; and/or, the distance variation between the second restricting edge 225 on the lower side of the mounting member 22 and the first restricting edge 2111 on the lower side of the first restricting portion 211 is between 0 mm and 10 mm.

In an embodiment, the spacing between the first restricting edge 2111 and the second restricting edge 225 located on the same side along the first direction H is not less than 0.1 mm (e.g., the spacing between the first restricting edge 2111 and the second restricting edge 225 located on the same side along the first direction H may take a value greater than or equal to 0.1 mm, such as 0.1 mm, 1 mm, 2 mm, 4 mm, 6 mm, 8 mm, or 10 mm); and/or, the spacing between the first restricting edge 2111 and the second restricting edge 225 located on the same side along the second direction W is not less than 0.1 mm (e.g., the spacing between the first restricting edge 2111 and the second restricting edge 225 located on the same side along the second direction W may take a value greater than or equal to 0.1 mm, such as 0.1 mm, 1 mm, 2 mm, 4 mm, 6 mm, 8 mm, or 10 mm). This ensures that the range of movement of the mounting member 22 relative to the fixed base 21 is not less than 0.1 mm.

In this embodiment, by restricting the range of movement of the mounting member to not less than 0.1 mm along the first and/or second direction, the fault tolerance capability of the three-dimensional printing apparatus can be improved. This ensures that even when there are significant deviations in the movement path accuracy of the load-carrying member 1, the positional accuracy of the storage device 2, and the positional accuracy of the load-carrying member 1, it is still possible to adjust the position of the mounting member 22 relative to the fixed base 21 to achieve precise alignment between the first limiting portion 11 and the second limiting portion 221. This allows the adjustment function of the storage device 2 to compensate for substantial positional errors, thereby enhancing the practicality of the storage device 2 and the success rate of assembling the load-carrying member 1. Furthermore, if the spacing between the first restricting edge 2111 and the second restricting edge 225 located on the same side along the first direction H is less than 0.1 mm, or if the spacing between the first restricting edge 2111 and the second restricting edge 225 located on the same side along the second direction W is less than 0.1 mm, the distance between the mounting member and the first restricting portion is too small, making the mounting member 22 prone to colliding with the first restricting portion of the fixed base 21 during movement, which could lead to damage to the mounting member 22 over time. In an embodiment, referring to FIGS. 2 and 3, the storage device 2 further includes a second restricting portion 26, which connects the fixed base 21 and the mounting member 22 to prevent the mounting member 22 from detaching from the fixed base 21 along the preset direction, thereby making the connection between the mounting member 22 and the fixed base 21 more secure.

The second restricting portion 26 may be connected to the mounting member 22 or the fixed base 21 by means of internal penetration; or, the second restricting portion 26 may be connected to the mounting member 22 by means of external enclosure.

It should be noted that, regardless of the form selected for the second restricting portion 26, in order to enhance the flexibility of the mounting member 22 during movement along the preset planar direction and to prevent excessive movement of the mounting member 22 along the preset direction, the second restricting portion 26 should enable the mounting member 22 to move along the preset direction with a range of movement not exceeding 1 mm. When an interference occurs between the first limiting portion 11 and the second limiting portion 221, the mounting member 22 is capable of undergoing a positional change along the preset planar direction following the first limiting portion 11. Meanwhile, the range of movement of the mounting member 22 relative to the fixed base 21 along the preset direction is not greater than 1 mm. The mounting member 22 mainly moves along the preset planar direction during movement, while its range of movement along the preset direction is very small. This avoids significant movement of the mounting member 22 simultaneously along both the preset planar direction and the preset direction, ensuring that the mounting member 22 essentially moves only along the preset planar direction. It reduces unnecessary movement of the mounting member 22 along the preset direction, allowing the second limiting portion 221 of the mounting member 22 to align more quickly with the first limiting portion 11 of the load-carrying member 1, thereby improving operational efficiency.

In an embodiment, referring to FIGS. 3 and 4, the load-carrying member 1 has a first mounting portion 27, and the mounting member 22 has a second mounting portion 28 magnetically attracted to the first mounting portion 27. In this embodiment, the load-carrying member 1 can be fixed to the mounting member 22 through magnetic attraction between the first mounting portion 27 and the second mounting portion 28, making the fixation of the load-carrying member 1 on the mounting member 22 more secure. At the same time, the mounting member 22 can still move back from the second position to the first position.

In this embodiment, the types of the first mounting portion 27 and the second mounting portion 28 are not limited. The first mounting portion 27 may be an object such as an iron plate that can be adsorbed onto a magnet, and the second mounting portion 28 may be a magnet; or, both the first mounting portion 27 and the second mounting portion 28 are magnets, with the first mounting portion 27 and the second mounting portion 28 having opposite magnetic polarities so that they attract each other.

In an embodiment, at least one of the first limiting portion 11 and the second limiting portion 221 has a guiding surface (such as a second guiding inclined surface 2211) at an end along the preset direction, the guiding surface intersects with the preset direction, and when the interference occurs between the first limiting portion 11 and the second limiting portion 221, the guiding surface is capable of converting the impact force applied by the first limiting portion 11 to the second limiting portion 221 along the preset direction into a force along the preset planar direction, thereby assisting in changing the position of the second limiting portion 221 along the preset planar direction.

For example, in FIG. 4, one of the first limiting portion 11 and the second limiting portion 221 is a plug, and the other is a slot; the insertion opening of the slot is provided with a first guiding inclined surface, and/or a free end of the plug is provided with a second guiding inclined surface 2211 that cooperates with the first guiding inclined surface. The first guiding inclined surface and the second guiding inclined surface 2211 serve a guiding function. When the plug contacts the first guiding inclined surface of the slot, the first guiding inclined surface can guide the plug to move so that the plug aligns with the slot. Once aligned, the plug can be inserted into the slot, thereby fixing the load-carrying member 1 to the mounting member 22.

In an embodiment, referring to FIGS. 3 and 4, when the load-carrying member 1 is provided in a plurality, the mounting member 22 extends along the first direction H, the second limiting portion 221 is provided in a plurality, the plurality of second limiting portions 221 are arranged at intervals along the first direction H, and the plurality of second limiting portions 221 correspond one-to-one and engage with the first limiting portions 11 of the plurality of load-carrying members 1. By providing the plurality of second limiting portions 221 on the mounting member 22, the mounting member 22 is enabled to assemble and fix the plurality of load-carrying members 1, enhancing the practicality of the mounting member 22. In this embodiment, the first direction H may be the length or height direction of the mounting member 22, which is not limited herein.

In an embodiment, referring to FIGS. 3 and 4, each of the first limiting portions 11 includes a plurality of first limiting sub-portions 112, each of the second limiting portions 221 includes a plurality of second limiting sub-portions 2212, and the plurality of first limiting sub-portions 112 are configured to correspond one-to-one and engage with the plurality of second limiting sub-portions 2212. In this embodiment, the design of the plurality of first limiting sub-portions 112 and the plurality of second limiting sub-portions 2212 can distribute the weight and force of the load-carrying member 1 across a plurality of points, effectively improving the installation stability between the load-carrying member 1 and the mounting member 22. In an embodiment, at least two of the plurality of second limiting sub-portions 2212 are arranged at intervals along the first direction H to improve assembly accuracy along the first direction H. Similarly, at least two of the plurality of second limiting sub-portions 2212 are arranged at intervals along the second direction W to improve assembly accuracy along the second direction W.

In an embodiment, referring to FIGS. 4 and 6, a side of the load-carrying member 1 facing the mounting member 22 is provided with a mounting surface, the plurality of first limiting sub-portions 112 and the first mounting portion 27 are all fixed on the mounting surface, and the first mounting portion 27 is fixed at a center of the mounting surface, with the plurality of first limiting sub-portions 112 arranged around a periphery of the first mounting portion 27. The center of the mounting surface is closer to the centroid of the load-carrying member 1. By fixing the first mounting portion 27 at the center of the mounting surface and arranging the plurality of first limiting sub-portions 112 around the periphery of the first mounting portion 27, it helps to achieve the overall balance of the load-carrying member 1, reducing the risk of the load-carrying member 1 tipping over due to a shift of the center of gravity.

In an embodiment, the type of the load-carrying member 1 is not limited, and the load-carrying member 1 may include a tool head of the three-dimensional printing apparatus.

The above provides a detailed introduction to the embodiments the present application. Specific examples are used herein to illustrate the principles and implementation manners of the present application. The description of the above embodiments is merely intended to aid in understanding the method and core concepts of the present application. Meanwhile, for those skilled in the art, based on the concepts of the present application, there may be modifications in the specific implementation manners and scope of application. In summary, the content of the specification should not be construed as limiting the present application.

What is claimed is:

1. A three-dimensional printing apparatus, comprising:
a load-carrying member having a first limiting portion; and
a storage device configured to store the load-carrying member and comprising a fixed base and a mounting member;
wherein the mounting member is movably disposed on the fixed base and has a second limiting portion configured to engage with the first limiting portion; and
the mounting member is configured to, when an interference occurs between the first limiting portion and the second limiting portion, move relative to the fixed base following movement of the first limiting portion, from a first position to a second position, so as to align and then engage the second limiting portion with the first limiting portion.

2. The three-dimensional printing apparatus of claim 1, wherein a range of movement of the mounting member relative to the fixed base is not less than 0.1 mm; and/or, the range of movement of the mounting member relative to the fixed base is not greater than 20 mm.

3. The three-dimensional printing apparatus of claim 1, wherein the second limiting portion is configured to engage with the first limiting portion in a nested manner along a preset direction; and
the mounting member is configured to, when the interference occurs between the first limiting portion and the second limiting portion, undergo a positional change relative to the fixed base along a preset planar direction following movement of the first limiting portion along the preset direction; and the preset direction is perpendicular to the preset planar direction.

4. The three-dimensional printing apparatus of claim 2, wherein the second limiting portion is configured to engage with the first limiting portion in a nested manner along a preset direction; and
the mounting member is configured to, when the interference occurs between the first limiting portion and the second limiting portion, undergo a positional change relative to the fixed base along a preset planar direction following movement of the first limiting portion along the preset direction; and the preset direction is perpendicular to the preset planar direction.

5. The three-dimensional printing apparatus of claim 3, wherein
a range of movement of the mounting member relative to the fixed base along the preset direction is not greater than 1 mm.

6. The three-dimensional printing apparatus of claim 4, wherein
a range of movement of the mounting member relative to the fixed base along the preset direction is not greater than 1 mm.

7. The three-dimensional printing apparatus of claim 3, wherein the fixed base has a first restricting portion configured to restrict a range of movement of the mounting member relative to the fixed base along the preset planar direction.

8. The three-dimensional printing apparatus of claim 4, wherein the fixed base has a first restricting portion configured to restrict a range of movement of the mounting member relative to the fixed base along the preset planar direction.

9. The three-dimensional printing apparatus of claim 7, wherein the first restricting portion has a first restricting edge, and the mounting member has a second restricting edge, the first restricting edge being capable of abutting against the second restricting edge to restrict the range of movement of the mounting member relative to the fixed base along the preset planar direction; a first direction and a second direction are perpendicular to each other, and both the first direction and the second direction are parallel to the preset planar direction; and
when the mounting member moves relative to the fixed base, along the first direction, a distance variation between the first restricting edge and the second restricting edge located on the same side does not exceed 10 mm; and/or, when the mounting member moves relative to the fixed base, along the second direction, a distance variation between the first restricting edge and the second restricting edge located on the same side does not exceed 10 mm.

10. The three-dimensional printing apparatus of claim 7, wherein the first restricting portion has a first restricting edge, and the mounting member has a second restricting edge, the first restricting edge being capable of abutting against the second restricting edge to restrict the range of movement of the mounting member relative to the fixed base along the preset planar direction; a first direction and a second direction are perpendicular to each other, and both the first direction and the second direction are parallel to the preset planar direction; and
a spacing between the first restricting edge and the second restricting edge located on the same side along the first direction is not greater than 10 mm; and/or, a spacing between the first restricting edge and the second restricting edge located on the same side along the second direction is not greater than 10 mm; and/or, the spacing between the first restricting edge and the second restricting edge located on the same side along the first direction is not less than 0.1 mm; and/or, the spacing between the first restricting edge and the second restricting edge located on the same side along the second direction is not less than 0.1 mm.

11. The three-dimensional printing apparatus of claim 3, wherein the storage device further comprises a second restricting portion connecting the fixed base and the mounting member to prevent the mounting member from detaching from the fixed base along the preset direction.

12. The three-dimensional printing apparatus of claim 11, wherein the second limiting portion is configured to engage with the first limiting portion in the nested manner along the preset direction; and
the fixed base has a first restricting portion configured to restrict a range of movement of the mounting member relative to the fixed base along the preset planar direction, and the preset direction is perpendicular to the preset planar direction.

13. The three-dimensional printing apparatus of claim 12, wherein the load-carrying member has a first mounting portion, the mounting member has a second mounting portion magnetically attracted to the first mounting portion, and the load-carrying member is fixed to the mounting member through magnetic attraction between the first mounting portion and the second mounting portion.

14. The three-dimensional printing apparatus of claim 3, wherein at least one of the first limiting portion and the second limiting portion has a guiding surface at an end along the preset direction, the guiding surface intersects with the preset direction, and the guiding surface is capable of assisting in changing a position of the second limiting portion along the preset planar direction when the interference occurs between the first limiting portion and the second limiting portion.

15. The three-dimensional printing apparatus of claim 1, wherein when the load-carrying member is provided in a plurality, the mounting member extends along a first direction, the second limiting portion is provided in a plurality, the plurality of second limiting portions are arranged at intervals along the first direction, and the plurality of second limiting portions correspond one-to-one and engage with the first limiting portions of the plurality of load-carrying members; and
each of the first limiting portions comprises a plurality of first limiting sub-portions, each of the second limiting portions comprises a plurality of second limiting sub-portions, the plurality of first limiting sub-portions are configured to correspond one-to-one and engage with the plurality of second limiting sub-portions, and at least two of the plurality of second limiting sub-portions are arranged at intervals along the first direction.

16. The three-dimensional printing apparatus of claim 2, wherein when the load-carrying member is provided in a plurality, the mounting member extends along a first direction, the second limiting portion is provided in a plurality, the plurality of second limiting portions are arranged at intervals along the first direction, and the plurality of second limiting portions correspond one-to-one and engage with the first limiting portions of the plurality of load-carrying members; and
each of the first limiting portions comprises a plurality of first limiting sub-portions, each of the second limiting portions comprises a plurality of second limiting sub-portions, the plurality of first limiting sub-portions are configured to correspond one-to-one and engage with the plurality of second limiting sub-portions, and at least two of the plurality of second limiting sub-portions are arranged at intervals along the first direction.

17. The three-dimensional printing apparatus of claim 15, wherein a side of the load-carrying member facing the mounting member is provided with a mounting surface, the first mounting portion and the plurality of first limiting sub-portions are all fixed on the mounting surface, and the first mounting portion is fixed at a center of the mounting surface, with the plurality of first limiting sub-portions arranged around a periphery of the first mounting portion.

18. The three-dimensional printing apparatus of claim 16, wherein a side of the load-carrying member facing the mounting member is provided with a mounting surface, the first mounting portion and the plurality of first limiting sub-portions are all fixed on the mounting surface, and the first mounting portion is fixed at a center of the mounting surface, with the plurality of first limiting sub-portions arranged around a periphery of the first mounting portion.

19. The three-dimensional printing apparatus of claim 1, wherein the load-carrying member comprises a tool head of the three-dimensional printing apparatus.

20. The three-dimensional printing apparatus of claim 2, wherein the load-carrying member comprises a tool head of the three-dimensional printing apparatus.
